(19) United States
(12) Patent Application Publication
(10) Pub. No.: US 2003/0191818 A1
(43) Pub. Date: Oct. 9, 2003

(54) Beacon network

(76) Inventors: Paul J. Rankin, Horley (GB); David C. Yule, Taipei (TW)

Correspondence Address: PHILIPS INTELLECTUAL PROPERTY & STANDARDS, P.O. BOX 3001, BRIARCLIFF MANOR, NY, 10510, US

(21) Appl. No.: 10/101,331

(22) Filed: Mar. 19, 2002

(30) Foreign Application Priority Data
Mar. 20, 2001 (GB) 0106844.4
Nov. 1, 2001 (GB) 0126216.1

(51) Int. Cl. G06F 15/16

(52) U.S. Cl. 709/219

(57) ABSTRACT

A communications system comprises a beacon (10) storing a portion of available data (20) and having access to all of the available data over a first network (60). The beacon (10) is arranged to communicate with a client terminal (30) over a second network (35, 40) to supply data from said stored portion (20) of available data. The client terminal (30) has access to all of the available data (70) over a third network (80, 90). Upon a request by the client terminal (30) for data of the available data not within the stored portion (20), a network is selected from the first network (30) and the third network (80, 90) in dependence on one or more predetermined criteria, the requested data being accessed over the selected network.

The present invention relates to mobile communications devices, such as telephones and suitably equipped personal digital assistants (PDA's), and to infrastructure systems and protocols for use with the same.

Recent years have seen a great increase in subscribers world-wide to mobile telephone networks. Through advances in technology and the addition of functionalities, cellular telephones have become personal, trusted devices. In addition, advances in wireless networking technology now allow handheld computing devices to wirelessly communicate with networked resources. A result of this is that a mobile information society is developing, with personalised and localised services becoming increasingly more important. Such “Context-Aware” (CA) terminals such as mobile telephones, PDA's and other wireless devices, are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

Commonly-assigned International patent application EP 01/06948 filed with a priority date of Aug. 15, 2000 and unpublished at the priority date of the present invention, describes a CA terminal and puts forward the concept of broadcasting data before a connection is made according to BlueTooth protocols. It exploits the BlueTooth Inquiry phase by extending the very short ID packet sent out during this mode and using the extra space thus gained to carry a small amount of information. This information can be BlueTooth system related data or one-way application data. This scheme has the potentially useful feature of being backwards-compatible with legacy BlueTooth devices that are not able to understand this extra field.

HTML web browsers commonly use a number of intelligent caching schemes that reduce network traffic and page loading delays. For example, on a new page request, a browser may look in its local page cache first, then pass on request to a caching proxy server, where pages recently or frequently accessed by any user of the server are cached, then finally issue a request to the origin server for the missing content. Pages transmitted over HTTP (or WTP in WAP) can contain some information about how long they are valid for to help the proxy server decide whether to use the cached copy of the data or not.

Wireless Application Protocol (WAP) is now a well-known technology, which delivers content in a format similar to web HTML, namely WML (wireless mark-up language), in ‘cards’ from a server, via a WAP gateway to a mobile client, such as phone or PDA, where it can be viewed by a number of different WML browser variants. These cards may be delivered to the client in ‘decks’, anticipating the content that the browsers are next likely to require, so they can be cached on the client to reduce networking delays. WML links and A/V assets may be referenced by absolute address or relative to the current WML source directory. Proxy gateway addressing is dependent on the bearer type. WAP protocols are layered above the bearer level, from application (WAE), to Session (WSP), to Transaction (WTP), to Security (WTLS), to the Transport layer (WDP) which rides on the underlying bearer. At the WDP level, ‘management entities’ may notify events such as client or server node being lost.

There are on-going standardisation discussions, involving both the WAP Forum and the BlueTooth (BT) committees about very local delivery of WAP over a BlueTooth pico-network as a possible short-range RF bearer technology. Therefore the sole use of either a BT, or a wide-area, network for sourcing WML content is already known. Moreover, there is already discussion on WAP session handover, from BT as a WAP bearer to an alternate bearer (eg wide-area network). For example, where a WAP client device supporting multiple bearers leaves a BlueTooth access point's coverage or loses the BT pico-network connection, the client then may query an alternate (wide-area) address for the WAP server, that information being sent and cached during the BlueTooth connection. In one example, a smart kiosk having both BT and WAP communication capabilities provides an Internet address for the continuation of information delivery using cellular packet data to resume the client-server session (ref.: section 4.1.2 of BlueTooth Draft Specification Document Version 1.0B ‘Interoperability Requirements for BlueTooth as a WAP bearer).

Allowing network access from multiple bearers is well understood in a fixed (‘wired’) environment. Systems on IP-based networks regularly use ‘routing tables’ which allow them to access different remote servers (with particular IP addresses) via different network connections.

In systems to date, localised data delivery over BlueTooth from a cache on a beacon is provided solely as an alternative to data delivery over a WAN, such as by WAP. One or the other delivery mechanism is used depending on terminal configuration and network availability.

According to a first aspect of the present invention, there is provided a communications system comprising a beacon storing a portion of available data and having access to all of the available data over a first network, the beacon being arranged to communicate with a client terminal over a second network to supply data from said stored portion of available data, the client terminal having access to all of the available data over a third network, wherein upon a request by the client terminal for data of the available data not within the stored portion, a network is selected from the first network and the third network in dependence on one or more predetermined criteria, the requested data being accessed over the selected network.

The present invention utilises the most favourable aspects of data access over two or more different networks. In one embodiment, a BlueTooth beacon communicates with a wide area network (WAN) over a first network and a mobile device over a second, BlueTooth, network. The mobile device also has the capability of accessing the WAN over a third, WAP, network. By using the predetermined criteria, intelligent selection is possible between the first and third networks for data access where the data is not stored by the beacon itself. Further in accordance with the present invention there is provided a portable communications device for use as said client terminal in a system as recited above, said device being operable to communicate with said beacon, to access said available data over said third network, and to generate said request for data of the available data not within the stored portion.

According to a second aspect of the present invention, there is provided a data supply method for supplying data to a client terminal comprising:

maintaining a beacon storing a portion of available data and having access to all of the available data over a first network;

communicating between the beacon and the client network over a second network to supply data from the stored portion of available data;

wherein the client terminal has access to all of the available data over a third network; the method further comprising the steps of:

upon request by the clients terminal for data of the available data not within the stored portion, selecting a network from the first network and the third network in dependence on one or more predetermined criteria; and,

accessing the requested data over the selected network.

The present invention focuses on the simultaneous and intelligent use of both networks for content access to the client terminal by intelligent distributed caching and the optional tailoring of content addressing.

When initiating a network connection (from a desktop or mobile environment), the decision to open the connection is usually a combination of the client software and the user. The present invention also proposes a solution which allows this decision to be made by a combination of the client software, the user and an already networked server.

An example of the present invention will now be described in detail with reference to the accompanying Figures, in which:

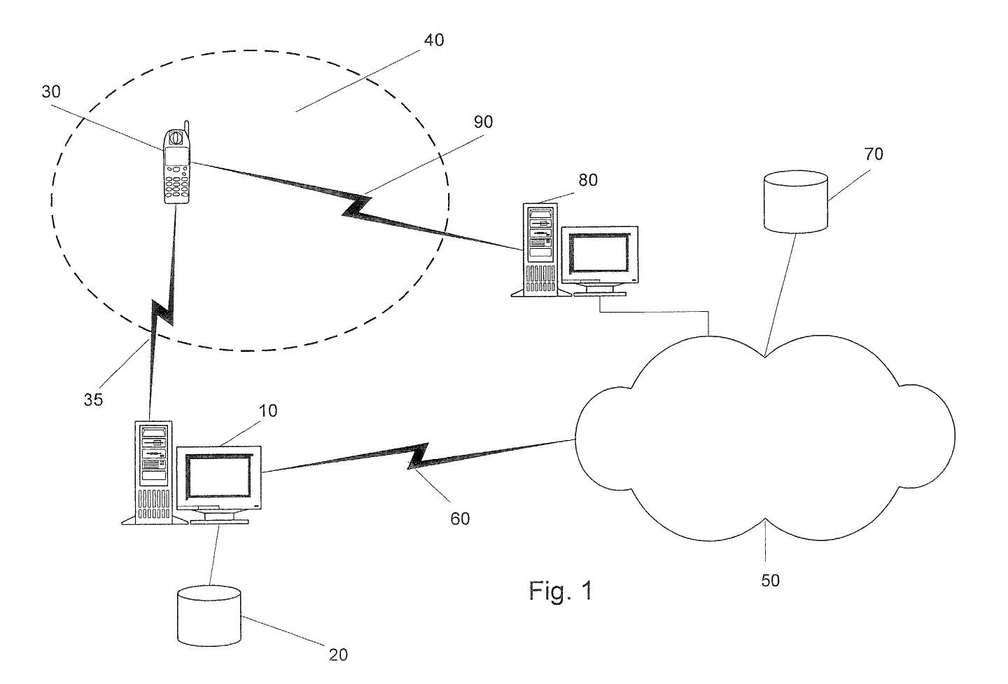

FIG. 1 is a schematic diagram of a beacon network illustrating one embodiment of the present invention; and,

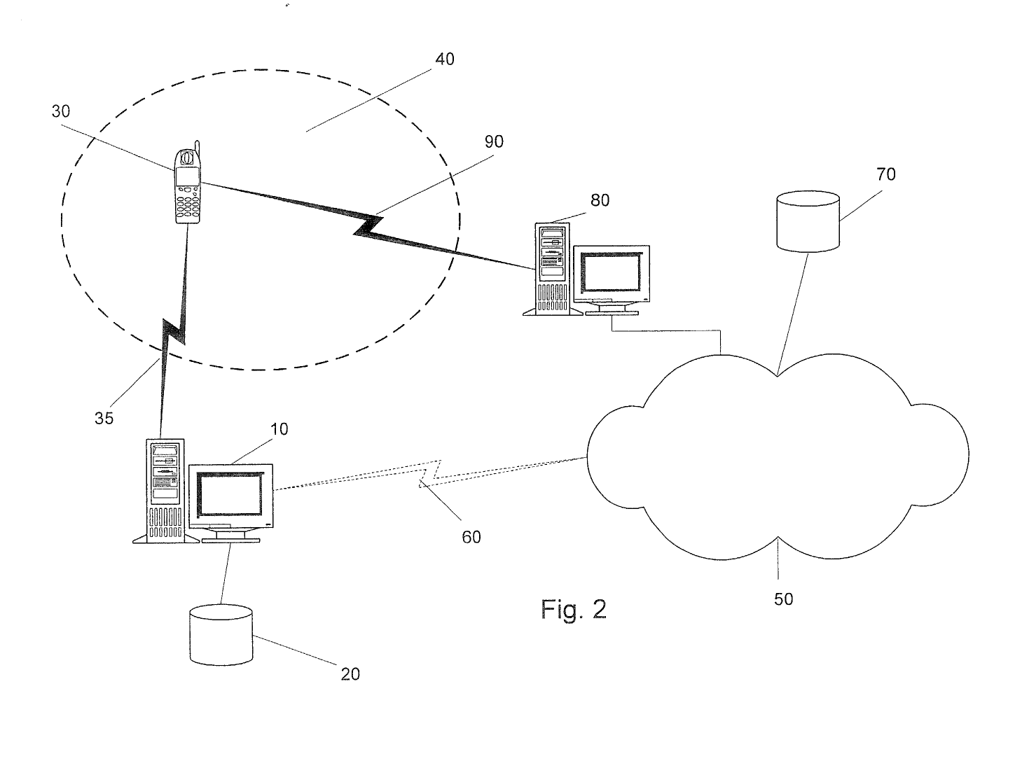

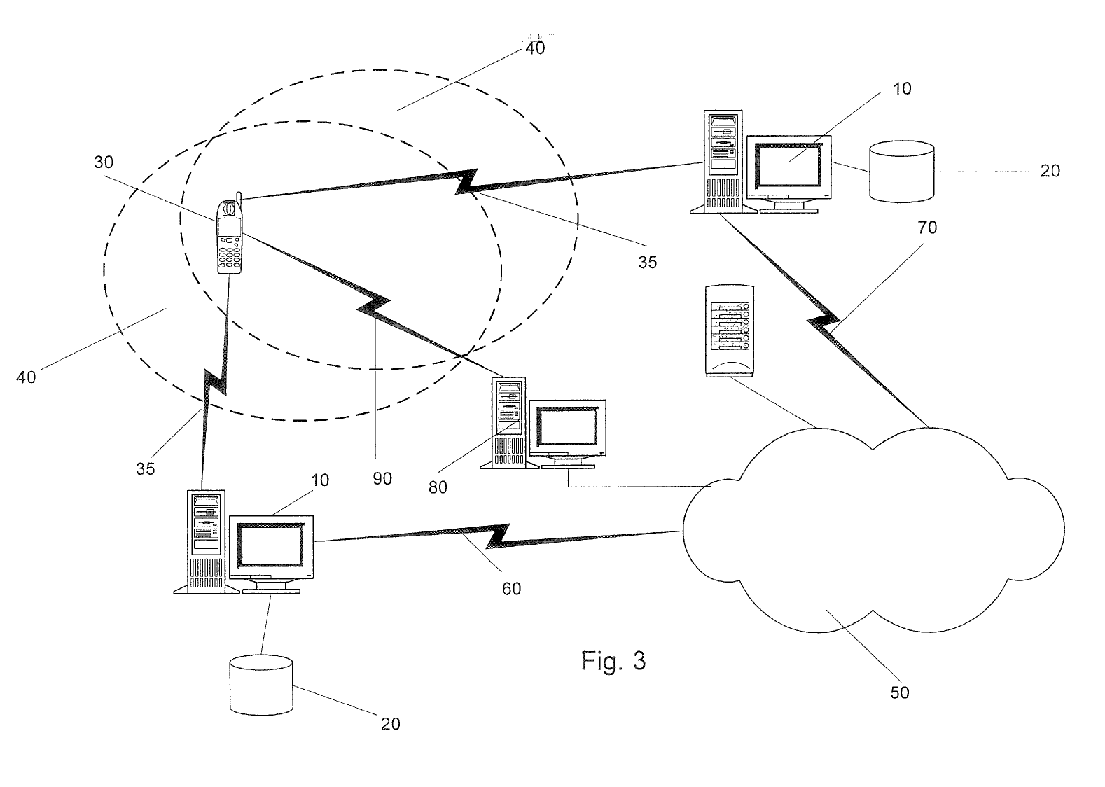

FIGS. 2 and 3 illustrate possible data supply source configurations; and,

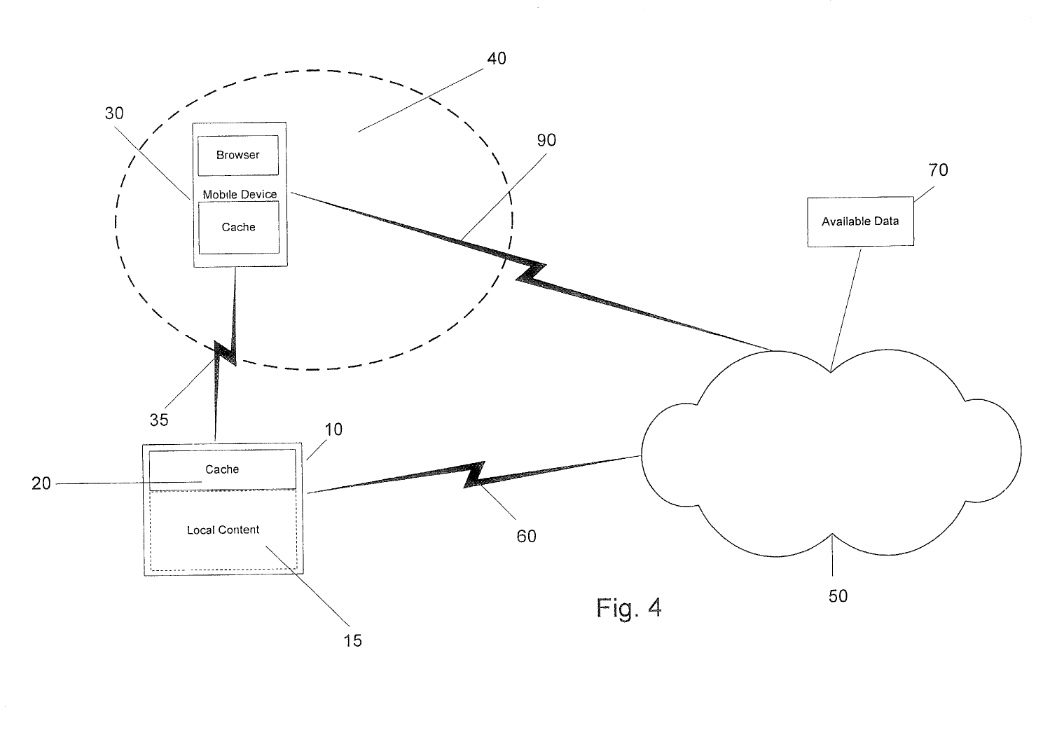

FIG. 4 is the schematic diagram of FIG. 1 illustrating selected aspects in more detail.

The measures proposed are illustrated by reference to WAP and WML, but are relevant to any IP-based or similar browsing protocol (e.g. iMode, WAP, HTML/HTTP, etc). One or more subsets of main WAP WML content is delivered over a short-range RF or IR link (in a single initial data burst or broadcast, or through a number of short-range beacon/handset exchanges) in preference to sourcing that content over a wide-area network. In one embodiment, a part of the total WML or other content is mirrored in the beacon's cache (or on a server behind the beacon).

FIG. 1 is a schematic diagram of a beacon network illustrating one embodiment of the present invention. A beacon 10 hosts a cache 20 of data. The beacon 10 operates in a BlueTooth pico-network. The broadcast area of the beacon 10 within the pico-network is illustrated as the area 40. A BlueTooth-enabled mobile device 30, such as a CA terminal in the form of a mobile telephone, PDA or other device within the beacon's 10 broadcast area 40 is able to communicate with the beacon 10 and obtain data via the BlueTooth pico-network from the cache 20. Data within the cache 20 is a subset of data available to the mobile device 30. The beacon 10 can connect to a data network 50 via a network connection 60. The available data, of which the data in the cache 20 is a subset, is held in one or more memory 70 that can be accessed via the data network 50. Whilst the memory 70 is illustrated as a single entity in FIG. 1, it will be apparent to the reader that the data can be stored in a number of memories accessible from the data network 50. Such memories could be hard disks of computers, online storage memories or other data storage media or services. Furthermore, the data network 50 could be one or more Intranets and/or the Internet. Additionally, the memory or memories could be websites or other web based resources.

The mobile device 30 is able to connect directly to the data network 50 via a portal 80. The data connection 90 between the mobile device 30 and the portal 80 may, for example, be a WAP data connection.

When the mobile device 30 requires access to data it communicates with the beacon 10 via a BlueTooth connection 35. In some situations data may be pushed from the beacon 10 via the BlueTooth connection 35 to the mobile device 30, for example, at certain times or when it enters the broadcast area 40. The beacon 10 supplies data from the subset of available data in the cache 20 to the mobile device via the BlueTooth connection 35. If some or all of the data required by the mobile device 30 is not within the subset of available data, the data network 50 is accessed to obtain the necessary available data from the memory(s) 70.

The supply source used to obtain the data network 50 is selected in dependence on a number of predetermined criteria. Examples of possible data supply configurations are illustrated with reference to FIGS. 2 and 3.

FIG. 2 is the schematic diagram of FIG. 1 illustrating a possible data supply source configuration according to an embodiment of the present invention. In this configuration the beacon 10 has no permanent connection to the data network 50. A connection 60 may be established temporarily, for example over a PSTN, possibly by manual intervention, to occasionally update the beacon's cache 20. In this manner, the beacon is effectively stand-alone and merely indicates data available from the data network 50.

For example, the beacon 10 may be positioned so its broadcast area 40 covers the premises and immediate vicinity of a shop. When a mobile device enters the broadcast area 40, the beacon 10 is a first supply source and transmits data from the cache 20 using BlueTooth to alert the mobile device 30 to, for example, products and/or services provided by the shop. In this example, detailed product and/or service information is not a part of the subset of data in the cache 20 and is instead held on a second data supply source in the form of a web site 70 accessible via the data network 50. Links to the detailed product and/or service information are provided within the subset of data from the cache 20 and form at least part of the predetermined criteria in this example. The links in this example could be WML or HTML redirection links pointing to the web site 70. When accessed by the mobile device, the links have the effect of instructing the mobile device to establish a WAP connection 90 to the portal 80 so that the mobile device can then access the data on the web site 70 associated with the link. In this configuration, the predetermined criteria would include the information and links embedded within the data from the beacon 10.

FIG. 3 is the schematic diagram of FIG. 1 illustrating a possible data supply configuration according to an embodiment of the present invention. In this configuration, the beacon 10 is again the first data supply source but uses an available network connection 60 to access the data network 50 and therefore the second data supply source in the form of a storage area network 70 for all data that is not stored within the cache 20. This may be the situation, for example, where an organisation owning the mobile device 30 also owns the beacon 10 and data network 50.

For example, the mobile device 30 may be provided for use within an office. A network of beacons 10 are maintained for allowing the mobile device 30 to obtain data from the storage area network (SAN) 70 on the office's intranet 50. In order to limit costs incurred by establishing connections to the portal 80, where possible, all traffic from the mobile device 30 is routed over BlueTooth via the data connection 35 to one of the network of beacons 10. Where data is requested that is not held within a cache 20, the respective beacon 10 accesses the intranet 50 via its network connection 60 to obtain the data from the SAN 70. The beacon 10 then relays the obtained data to the mobile device 30 via the BlueTooth data connection 35.

In order to achieve a configuration in which all links are initially followed back to a beacon 10, the links could be written (or rewritten if the data in the cache 20 is an actual copy of data from the SAN) to point to the beacon 10 instead of resources elsewhere. One alternative is for the mobile device 30 to be configured, or instructed by data received from the beacon 10, to direct all communications, irrespective or the address of the link, to one of the beacons 10.

When a beacon receives a request for a link that is not held within the cache 20, the link is redirected to the SAN 70. The data is then obtained by the beacon 10 and forwarded to the mobile device 30.

Only in the event that a BlueTooth connection 35 cannot be established between the beacon 10 and mobile device 30 would the mobile device 30 seek the data via connection 90 with the portal 80 to obtain the data from the SAN 70 directly. However, the configuration of the mobile device 30 and/or data embedded within data provided from the cache 20 may limit or prevent access to the SAN 70 via the portal 80.

FIGS. 2 and 3 illustrate extreme situations, where after receiving an alert from the beacon 10, the mobile device 30 starts up a data connection using different data supply sources. Pointers or links within the alert from the beacon 10 provide the necessary instructions to the mobile device 30 to activate a relevant service over a wide-area, eg cellular link, or directly with the beacon 10, the latter being supplied with the service content (eg WML). For commercial reasons (for example generating network operator traffic or connection charges) there may be preferences for either of these configurations.

Technically, the configuration illustrated with reference to FIG. 2 has the advantage that the WML, HTML or other content is maintained at one main server site 70. However, delays may be experienced from the wide area network and gateway initialisation times before any content is seen on the mobile device 30. In the configuration illustrated with reference to FIG. 3 on the other hand delays may be experienced when the beacon's cache 20 must retrieve additional content from its back-end network 50 via network connection 60, or the fact that the beacon cache's content may become out of date, and so needs to track changes to that of the main content site 70. In general, bandwidth limitations, connection costs, quality of service or network security of either the short-range RF link, or of the wide-area network may also dictate preferences for content delivery of short message, audio or video, commercial transactions etc over one, rather than the other network. These latter preferences may vary for different parts of the same complete body of a service's content and also be dependent on the device characteristics of the mobile handset. Each preference, mobile device configuration, network availability and policy decision may be a predetermined condition used in the present invention to determine the data source to be used.

In a typical WAP type data access scenario, the mobile device's content browser intelligently asks for the WML cards it is likely to need (when they are not held in the handset's own cache), either from the beacon 10 or from the network 50, dependent on the predetermined conditions. For example, if delay times or cellular charges are paramount, then content may be initially requested from the beacon 10 (if it is known to be cached there and the beacon is still in range), then failing that from the wide-area network 50 via portal 80. If a secure transaction could not be offered over the short-range link 35, the mobile device 30 may continue that part of the service interaction with a secure wide-area link, and later return to the short-range interaction, eg for higher-bandwidth audio content delivery.

When the beacon 10 sends cached data to the mobile device 30, it may also provide information about the data which allows the mobile device 30 to decide intelligently whether it should, for example:

Use this data directly

Request the original data over the wide area network 50 via portal 80, or

Initiate a connection 90 to the wide area network 50 while using (for the moment) the locally cached data.

For example, the user could be interacting with first-level WML menus delivered from the beacon 10 while waiting for a wide-area WAP gateway 80 to get started, thus camouflaging the wide-area gateway 80 start-up delays. The top-level (‘keeping the user interested’) menus and WML content might be sent in the first burst from a beacon 10, with the hanging ‘leaves’ of that WML link tree having altered WML absolute addresses. These leaves may then be followed by the mobile device's browser over the wide-area bearer 90, even if the beacon 10 is still in range. (Subsequent beacon communication for interaction within those top-levels of WML is also possible at any stage). Some WAP browsers on mobile devices 30 already cache a ‘deck’ of WML cards locally on the mobile devices 30 and know when to update it from a server. There are now with 2 possible sources for the new cards/decks:

1. beacon cache 20; and,

2. wide-area gateway 80.

If content is to be cached by a beacon 10, indirection to relative or absolute links contained within the content may be needed. Automatic or regular updating of the beacon's cached content against changes to the content on the main site 70 may also be utilised.

Intelligence may be included in the mobile device's browser to identify when the beacon connection 35 is still available and what content it can deliver in addition to preferences for sources of different types of content (these preferences will typically form part of the predetermined criteria).

An embodiment of the invention is shown in FIG. 4. Two basic approaches (which can be combined) to storing the data on the beacon are illustrated:

i) No caching model. The beacon 10 includes an optional server 15. Content is stored on the beacon 10 with an address in the form of a URI (Universal Resource Identifier) that is unique to the beacon 10. The mobile device 30 must receive the content from the beacon 10 (the URI is not accessible from another server on the wide-area network 50).

ii) Caching model. The beacon 10 does not use the optional server 15. Content from servers 70 on the network 50 is cached by the beacon 10. The data, along with it's network URI and other meta-information, is copied from the network 50 onto the beacon 10. When this data is accessed by the mobile device 30, the data bears the same URI from the beacon 10 as it did when the beacon 10 obtained it from the origin server 70.

The beacon 10 has its own unique IP address and server (This does not assume that the beacon is connected to any network). An example of the process for communication is then as follows:

a) Mobile device 30 comes in range 40, short range (eg BT/Irda) connection 35 is started.

b) Beacon 10 does basic push of information (e.g. ‘cheap chocolate for sale’ WML page with profile information).

c) The mobile device 30 can then access the data in the form of pages on the beacon 10 (whether they are cached pages or pages from the local beacon server).

d) When the mobile device 30 requires a page having a URI outside the beacon 10 (i.e. on the network ‘at large’), the mobile device 30 must open a GSM/GPRS/3G or other suitable data connection 90 and continue to interact on this. This can also happen when the client requests a URI for data which is cached by the beacon 10, but which has associated meta-information which implies the data is out of date (e.g. Expiration-date in the HTTP header).

Further areas in which the configuration of the mobile device 30 or beacon 10 could be improved for use in the present invention include:

1. Predicting a request for a WAN connection in time to set it up (e.g. GSM-CSD requires approximately 20 seconds). The prediction is most suited to being done on the beacon 10 (it knows the layout of its own cached pages better than the mobile device 30). Device profile information about the mobile device 30 could be provided to the beacon 10 in order to aid this decision making process. (eg. What is the alternative data connection type? How long does it take to setup a connection?).

Some possible strategies for prediction are:

->User hits a ‘flag’ page (This could be first page or when user shows interest in browsing. It could also be a page which implies interest in purchasing something or searching for something which requires connection to an e-Commerce server).

->User makes more than X requests for pages (implying the user has time to ‘surf’).

->An explicit option is provided on a page (eg. ‘press button to initiate network connection’).

2. Initiating setup of WAN connection. To initiate setup, you could simply get the mobile device 30 to make a background ‘dummy’ request for data from the WAN 50 (Ideally this is accomplished by a HTTP (or similar) header being sent from the beacon 10 to mobile device 30. Alternatively the beacon 10 may include a ‘blank’ remote image URL in a cached page sent to the mobile device 30 causing the mobile device 30 to request the URL automatically). This could result in a message to user ‘Do you want to connect to network?’

3. Controlling network configuration of the client. Typically, the client dynamically controls its connection to the beacon(s) 10 and the WAN 50. Information Provider (IP) routing tables and DNS (Domain Name Servers—the system for mapping a domain name e.g. www.yule.org to an IP address e.g. 64.176.92.219) could therefore be intelligently used as part of the predetermined criteria. If the beacon 10 is networked, then this comes down to a decision on cost vs. bandwidth vs. latency vs. convenience (you can access the same URL via BlueTooth or via GPRS.) If the beacon 10 is not networked then the routing table should allow only requests to cache-based IP address(es) to go via the beacon 10, and the beacon 10 should also provide a DNS service (name server) for itself. The mobile device 30 then requires intelligence so that if the request for a URL fails due to unknown domain name at the beacon 10, it should initiate 1 WAN network connection 90 (if, and only if the routing table is ‘incomplete’=does not cover all possible IP addresses). Once connected, domain name servers at both the beacon and the network side are both accessible for future URL requests.

4. Mobile device/cache communication. A wired cache assumes that the client routes all requests through it (the cache machine decides whether to, and then does the network request). In the beacon model, requests only get routed to the cache if the page is stored there—it will be the client which makes the network request. When the client makes a request, the cache returns the page (if stored) with meta-data (date stored, expiration date, does it require revalidation? etc.), the client then displays the page or starts network connection dependent on this information.

5. Cache control extensions. HTTP1.1 (and so WTP) define a set of cache control primitives, these could be extended for the wireless (not always connected) world:

->X-if-networked (e.g. expire-if-networked, revalidate-if-networked, . . . ) i.e. allow the behaviour of pages to be different dependent on the network status of client (and also allow behaviour to change when the client comes online)

->revalidate-asynchronous. Request that the pages are checked for validity, but asynchronously. i.e. continue to display the page while the network is opened/checked.

6. Setup/reconfiguration/teardown. Setup so that the beacon cache 20 is used on connection is fairly simple (e.g. WAP over BlueTooth is already being discussed & demonstrated). However, reconfiguration when the mobile device connects to the wide-area network 50, and also teardown when the client disconnects from either the beacon 10 or the wide-area network 50 must also be considered. This is made simple by combining points (iii) & (iv) above:

When wide-area network connection is established, the mobile device 30 must access domain name servers at both the beacon 10 and the network side to be able to establish correctly IP addresses.

The web cache on the beacon 10 will still be accessible after network reconfiguration (and the mobile device 30/user can decide whether to use it or not). Also, any web server on the beacon 10 will still be accessible.

When the beacon 10 is no longer in range 40, the mobile device 30 can reconfigure to no longer attempt to use the beacon cache 20 or name server.

7. Automatic update of the beacon cache 20. When the mobile device 30 connects to the wide area network 50 to obtain an update of an out-of-date cached page, it can also send the data to the cache 20 to update its store (as a low-priority task). This assumes a reasonably high-bandwidth and free local connection to the beacon 10.

Although the above embodiments have been described to specific hardware configurations, it will be apparent to the skilled reader that these could be varied without any inventive input. For example, the BlueTooth beacon could be a server or a network of beacons. The mobile device could be a PDA, mobile phone or other device capable of communication with a number of networks. Furthermore, whilst specific communication protocols have been discussed, these could easily be substituted for others (GPRS or UMTS instead of WAP; a LAN instead of a WAN etc.)

1. A communications system comprising a beacon storing a portion of available data and having access to all of the available data over a first network, the beacon being arranged to communicate with a client terminal over a second network to supply data from said stored portion of available data, the client terminal having access to all of the available data over a third network, wherein upon a request by the client terminal for data of the available data not within the stored portion, a network is selected from the first network and the third network in dependence on one or more predetermined criteria, the requested data being accessed over the selected network.

2. A communications system according to claim 1, in which the second network is a BlueTooth network.

3. A communications system according to claim 1, in which the third network is a wireless communication network.

4. A communications system according to claim 3, in which the client terminal accesses the available data over the third network using a selected one of WAP, GPRS or UMTS.

5. A communications system according to claim 1, in which the beacon is arranged to supply data from the stored portion of available data to a client terminal over the second network prior to any request for data from the client terminal.

6. A communications system according to claim 1, in which the predetermined criteria include one or more of: user preference; configuration of the client terminal; network preference associated with the client terminal; availability of connection to the first and third networks; availability of a predetermined bandwidth level from a connection; and, security provided from a connection.

7. A communications system according to claim 1, wherein if data to be supplied from the stored portion of available data is older than a predetermined age, the data is refreshed from the available data via the first network or the third network selected in dependence on the one or more predetermined criteria.

8. A communications system according to claim 7, in which the data older than the predetermined age is supplied to the client terminal, and replaced by the refreshed data once obtained.

9. A communications system according to claim 7, in which the data older than the predetermined age stored by the beacon is replaced by the refreshed data.

10. A communications system according to claim 1, in which the predetermined criteria for selection of the third network include one or more of: selection of an explicit option at the client terminal by a user; a predetermined number of requests for data not within the stored portion; and, command within data supplied to the client terminal.

11. A data supply method for supplying data to a client terminal comprising:
maintaining a beacon storing a portion of available data and having access to all of the available data over a first network;
communicating between the beacon and the client network over a second network to supply data from the stored portion of available data;
wherein the client terminal has access to all of the available data over a third network; the method further comprising the steps of:
upon request by the clients terminal for data of the available data not within the stored portion, selecting a network from the first network and the third network in dependence on one or more predetermined criteria; and,
accessing the requested data over the selected network.

12. A method according to claim 11, further comprising the step of supplying data from the stored portion of available data from the beacon to a client terminal over the second network prior to any request for data from the clients terminal.

13. A method according to claim 11, in which the predetermined criteria include one or more of: user preference; configuration of the client terminal; network preference associated with the client terminal; availability of connection to the first and third networks; availability of a predetermined bandwidth level from a connection; and, security provided from a connection.

14. A method according to claim 10, further comprising the steps of determining if data to be supplied from the stored portion of available data is older than a predetermined age and, if so, refreshing the data from the available data via the first network or the third network in dependence on the one or more predetermined criteria.

15. A method according to claim 14, further comprising the step of supplying the data older than the predetermined age to the client terminal and replacing the supplied data by the refreshed data once obtained.

16. A method according to claim 14, further comprising the step of replacing the data older than the predetermined age stored by the beacon by the refreshed data.

17. A method according to claim 11, in which the predetermined criteria for selection of the third network include one or more of: selection of an explicit option at the client terminal by a user; a predetermined number of requests for data not within the stored portion; and, a command within data supplied to the client terminal.

18. A computer program comprising computer program code means for performing all the steps of claim 11 when said program is run on a computer.

19. A computer program as claimed in claim 18 embodied on a computer readable medium.

20. A portable communications device for use as said client terminal in a system as claimed in claim 1, said device being operable to communicate with said beacon, to access said available data over said third network, and to generate said request for data of the available data not within the stored portion.
